(19) United States
(12) Patent Application Publication
(10) Pub. No.: US 2025/0153152 A1
(43) Pub. Date: May 15, 2025

(54) COMPOSITE CATALYST, AIR PURIFICATION DEVICE INCLUDING THE SAME, AND METHOD OF PREPARING COMPOSITE CATALYST

(71) Applicants: Samsung Electronics Co., Ltd., Suwon-si (KR); Research & Business Foundation SUNGKYUNKWAN UNIVERSITY, Suwon-si (KR)

(72) Inventors: Hyeonsu Heo, Suwon-si (KR); Jiman Kim, Suwon-si (KR); Min Seok Koo, Suwon-si (KR); Mijong Kim, Suwon-si (KR); Hyun Chul Lee, Suwon-si (KR); Dongjin Ham, Suwon-si (KR); Jaewon Lee, Suwon-si (KR)

(21) Appl. No.: 18/914,771

(22) Filed: Oct. 14, 2024

(30) Foreign Application Priority Data
Nov. 14, 2023 (KR) 10-2023-0157699

(51) Int. Cl. B01J 29/06; B01J 35/45; B01J 35/63; B01J 35/64; B01J 35/80; B01J 37/02; B01J 37/08

(52) U.S. Cl. CPC B01J 29/06; B01J 35/45; B01J 35/63; B01J 35/647; B01J 35/80; B01J 37/0207; B01J 37/08; B01J 2229/37; B01J 2235/15

(57) ABSTRACT

A composite catalyst, wherein the composite catalyst includes a support including an aluminosilicate wherein the aluminosilicate comprises an amorphous aluminosilicate, and a first particle disposed on the support, the first particle including a metal, a metal oxide, or a combination thereof, wherein the composite catalyst is effective to remove a first compound from an unpurified air stream including the first compound.

### CROSS-REFERENCE TO RELATED APPLICATION

This application is based on and claims priority to Korean Patent Application No. 10-2023-0157699, filed on Nov. 14, 2023, in the Korean Intellectual Property Office, and all the benefits accruing therefrom under 35 U.S.C. § 119, the content of which is incorporated by reference herein in its entirety.

### BACKGROUND

### 1. Field

The disclosure relates to a composite catalyst, an air purification device including the composite catalyst, and a method of preparing a composite catalyst.

### 2. Description of the Related Art

For the removal of airborne pollutants, a technique of removing pollutants using a material with a large specific surface area is often used.

Zeolite is an example of such a material having a large specific surface area. However, removing pollutants using zeolite has a limited capacity. There remains a need for an improved material to remove pollutants.

### SUMMARY

Methods of removing pollutants using a material with a large specific surface area, e.g., zeolite, or methods of removing pollutants using zeolite as a catalyst support, have been used.

Because the pores in zeolite are predominantly micropores with a size of less than 2 nanometers (nm), such micropores may hinder the mass transfer via zeolite and may result in a decrease in the capacity to remove pollutants.

To improve the capacity of zeolite to remove pollutants, a zeolite-supported catalyst, which has catalyst particles supported on zeolite, may be used, however, agglomeration of catalyst particles or the like may limit catalytic activities.

In this context, there is a need for a novel composite catalyst that has facilitated mass transfer and suppressed agglomeration of supported catalyst particles.

Provided is a composite catalyst which provides increased removal capability for a volatile organic compound by having a novel structure.

Provided is an air purification device including the composite catalyst.

Provided is a method of preparing the composite catalyst.

Additional aspects will be set forth in part in the description which follows and, in part, will be apparent from the description, or may be learned by practice of the presented embodiments of the disclosure.

According to an aspect of the disclosure,
a composite catalyst includes:
a support including an aluminosilicate, wherein the aluminosilicate includes an amorphous aluminosilicate; and
a first particle supported on the support,
wherein the first particle includes a metal, a metal oxide, or a combination thereof, and the composite catalyst is effective to remove a first compound from an unpurified air stream comprising the first compound.

According to another aspect of the disclosure,
an air purification device includes:
a housing; and
the composite catalyst,
wherein the composite catalyst is disposed within the housing.

According to another aspect of the disclosure, a method of preparing a composite catalyst includes:
providing an aluminosilicate;
contacting the aluminosilicate and an alkaline solution to prepare an alkali-treated aluminosilicate;
performing a first heat-treatment on the alkali-treated aluminosilicate to prepare a heat-treated porous aluminosilicate;
contacting the heat-treated porous aluminosilicate and a strong acid to prepare an acid-treated aluminosilicate;
contacting the acid-treated aluminosilicate and a precursor solution of a first particle to prepare an aluminosilicate having a precursor of the first particle supported thereon; and
performing a second heat-treatment on the aluminosilicate with the precursor of the first particle supported thereon to prepare the composite catalyst.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a graph of intensity (arbitrary units, a.u.) vs. diffraction angle (°2θ) and shows the results of an X-ray diffraction (XRD) analysis for composite catalysts prepared in Example 1 and Comparative Examples 1 and 2;

FIG. 2 is a graph of differential pore volume (dVₚ/d log dₚ, cm³/g) vs. average pore size (nanometers, nm) and shows a pore size distribution curve showing the results of a nitrogen adsorption test on the composite catalysts prepared in Example 1 and Comparative Examples 1 and 2;

FIG. 3A is a scanning electron microscope (SEM) image of the composite catalyst prepared in Example 1;

FIG. 3B is a SEM image of the composite catalyst prepared in Comparative Example 1;

FIG. 4A is a cross-sectional SEM image of the composite catalyst prepared in Example 1;

FIG. 4B is a cross-sectional SEM image of the composite catalyst prepared in Comparative Example 1;

FIG. 5 is a graph of CO₂ conversion (%) vs. temperature (° C.) showing the results of a toluene decomposition test on the composite catalysts prepared in Example 1 and Comparative Examples 1 and 2;

FIG. 6 is a schematic diagram of an embodiment of a catalytic filter;

FIG. 7 is a front view of an inflow side of the catalytic filter illustrated in FIG. 6, through which unpurified air is introduced;

FIG. 8 is a front view of an outflow side of the catalytic filter illustrated in FIG. 6, through which purified air is discharged;

FIG. 9 is a cross-sectional view of the catalytic filter illustrated in FIG. 6, taken along line 4-4′ as indicated in FIG. 7; and

FIG. 10 is an expanded cross-sectional view of a first portion Al in FIG. 9.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. Rather, these embodiments are provided so that this disclosure will be thorough and complete, and will fully convey the scope of the invention to those skilled in the art. As used herein, the term “and/or” includes any and all combinations of one or more of the associated listed items. Expressions such as “at least one of,” when preceding a list of elements, modify the entire list of elements and do not modify the individual elements of the list.

The present inventive concept, which will be more fully described hereinafter, may have various variations and various embodiments, and specific embodiments will be illustrated in the accompanied drawings and described in greater detail. However, the present inventive concept should not be construed as being limited to specific embodiments set forth herein. Rather, these embodiments are to be understood as encompassing all variations, equivalents, or alternatives included in the scope of the present inventive concept.

The terminology used hereinbelow is used for the purpose of describing particular embodiments only, and is not intended to limit the present inventive concept. As used herein, the singular forms are intended to include the plural forms as well, unless the context clearly indicates otherwise. As used herein, the terms “comprises” and/or “comprising,” or “includes” and/or “including” specify the presence of stated features, regions, integers, steps, operations, elements, components, ingredients, materials, or combinations thereof, but do not preclude the presence or addition of one or more other features, regions, integers, steps, operations, elements, components, ingredients, materials, or combinations thereof. As used herein, “/” may be interpreted as “and”, or as “or” depending on the context.

In the drawings, the thicknesses of layers and regions may be exaggerated for clarity of description. Like reference numerals denote like elements throughout the specification. Throughout the specification, when a component, such as a layer, a film, a region, or a plate, is described as being “above” or “on” another component, the component may be directly above the another component, or there may be yet another component therebetween. In contrast, when an element is referred to as being “directly on” another element, there are no intervening elements present. It will be understood that although the terms “first,” “second,” etc. may be used herein to describe various elements, components, regions, layers and/or sections these elements components, regions, layers and/or sections should not be limited by these terms. These terms are only used to distinguish one element, component, region, layer or section, from another element, component, region, layer or section. In the present specification and the drawings, elements that serve substantially the same function are labeled with the same reference numeral and may not be discussed redundantly.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value. Endpoints of ranges may each be independently selected.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless otherwise defined, the term “size” of a particle may refer to “particle diameter” of the particle.

The term “particle diameter” of particles, as used herein, refers to an average diameter if the particles are spherical, and refers to an average major axis length if the particles are non-spherical. The particle diameter of particles may be measured using a particle size analyzer (PSA). The term “particle diameter” of particles, as used herein, refers to, for example, an average particle diameter. Average particle diameter may be, for example, a median particle diameter (D50). Median particle diameter (D50) may refer to a particle size corresponding to a cumulative volume of 50 vol % as counted from the smallest particle size in a particle size distribution measured by a laser diffraction method. Alternatively, “average particle diameter” may be measured by software or a manual from a scanning electron microscope (SEM) image or a transmission electron microscope (TEM) image.

The term “metal” as used herein refers to both metals and metalloids such as silicon and germanium, in an elemental or ionic state.

Hereinafter, a composite catalyst, an air purification device including the same, and a method of preparing a composite catalyst according to embodiments will be described in greater detail.

### Composite Catalyst

A composite catalyst according to an embodiment may be configured to remove a first compound from unpurified air stream containing the first compound. The composite catalyst may include a support containing an amorphous aluminosilicate, and a first particle disposed (e.g., supported) on the support. The first particle may include a metal, a metal oxide, or a combination thereof.

Because the composite catalyst includes a support including the amorphous aluminosilicate, and the first particle supported on the support, the ability of the composite catalyst to remove various volatile organic compounds present in unpurified air may improve.

In an aspect, the composite catalyst comprises: a support comprising an aluminosilicate, wherein the aluminosilicate comprises an amorphous aluminosilicate; and a first particle disposed on the support, wherein the first particle comprises a metal, a metal oxide, or a combination thereof, and the composite catalyst is effective to remove a first compound from an unpurified air stream comprising the first compound.

When the composite catalyst is analyzed by X-ray diffraction (XRD) using Cu Kα radiation λ=1.54178 Å, the intensity ratio (Ia/Ib) of a first peak intensity (Ia) to a second peak intensity (Ib) may be 0.5 or less, 0.4 or less, 0.3 or less, 0.2 or less, or 0.1 or less, wherein the first peak is a maximum peak intensity originating from the aluminosilicate at a diffraction angle (° 2θ) of about 5° 2θ to about 30° 2θ, and the second peak is a maximum peak intensity originating from the first particle at a diffraction angle of about 5° 2θ to about 90° 2θ, in an aspect, at a diffraction angle 2θ=about 5° to about 35°. The intensity ratio (Ia/Ib) of the first peak intensity (Ia) to the second peak intensity (Ib) may be 0 to about 0.5, 0 to about 0.4, 0 to about 0.3, 0 to about 0.2, or 0 to about 0.1. With the composite catalyst having peak intensities in the aforementioned ranges, the composite catalyst may show further improved performance of removal of volatile organic compounds.

The composite catalyst may include the support, the support may include the amorphous aluminosilicate, and the support may further include a crystalline aluminosilicate. The support may include an amorphous phase and a crystalline phase simultaneously in the aluminosilicate. The support may have a degree of crystallinity of, for example, 50% or less, 40% or less, 30% or less, 20% or less, or 10% or less. The degree of crystallinity of the support may be, for example, about 1% to about 50%, about 1% to about 40%, about 1% to about 30%, about 1% to about 20%, or about 1% to about 10%. With the support having the degree of crystallinity in the aforementioned ranges, the composite catalyst may show further improved performance of removal of volatile organic compounds. The degree of crystallinity may be an area under crystalline peaks (Ac) divided by a total sum of an area under amorphous peaks (Aa) and the area under the crystalline peaks (Ac), multiplied by 100 percent ([Ac/(Aa+Ac)]×100%), as obtained from an XRD spectrum of the support (e.g., support particles), using Cu Kα radiation λ=1.54178 Å. The degree of crystallinity may be measured according to, for example, ASTM D3906 and ASTM D5758.

The support may have a size of, for example, about 0.5 micrometer (μm) to about 500 μm, about 0.5 μm to about 100 μm, about 0.5 μm to about 50 μm, about 0.5 μm to about 10 μm, or about 1 μm to about 5 μm. With the support having the size in the aforementioned ranges, the composite catalyst may show further improved performance of removal of volatile organic compounds. The size of the support may be, for example, a diameter of the support measured from a scanning electron microscope image or a transmission electron microscope image. The size of the support may be, for example, an average particle diameter. The average particle diameter may be measured using, for example, a measurement device using a laser diffraction technique or a dynamic light scattering technique. The average particle diameter is measured using, for example, a laser scattering particle size distribution system (e.g., LA-920 Horiba), and the average particle diameter may be a value of median particle diameter (D50) at 50% from the smallest particle based on volume on a cumulative particle distribution.

The support may include, for example, an irregular particle, a spherical particle having an aspect ratio of less than about 2, a non-spherical particle having an aspect ratio of about 2 or greater, or a combination thereof. The spherical particle may have an aspect ratio of, for example, about 1.9 or less, about 1.5 or less, or about 1.2 or less. The spherical particle may have a sphericity of, for example, about 0.85 or greater, about 0.9 or greater, or about 0.95 or greater. The sphericity of a particle may be calculated from, for example, ψ=[π^{1/3}(6V_{particle})^{2/3}]/Aₚ, wherein ψ represents sphericity, V_{particle} represents a volume of the particle, and Aₚ represents a surface area of the particle. A roundness of the spherical particle, based on a 2D projected image of the particle, may be, for example, about 0.85 or greater, about 0.9 or greater, or about 0.95 or greater. The roundness of the spherical particle may be calculated by C=[4πA]/P², wherein C represents roundness, A represents the surface area of the particle, and P represents a perimeter of the particle. The non-spherical particles may have an aspect ratio of, for example, about 2 or greater, about 2.5 or greater, or about 3 or greater. The aspect ratio of the non-spherical particle may be, for example, about 2 to about 100, about 2.5 to about 100, or about 3 to about 100. The non-spherical particle may have a sphericity of less than about 0.8, for example, about 0.01 to about 0.8, about 0.1 to about 0.6, or about 0.2 to about 0.4. The sphericity of the non-spherical particle based on a two-dimensional image may be less than about 0.8, for example, about 0.01 to about 0.8, about 0.1 to about 0.6, or about 0.2 to about 0.4. The non-spherical particle may include, for example, a tube-shaped particle, a plate-shaped particle, a needle-shaped particle, a rod-shaped particle, a fibrous particle, or a combination thereof.

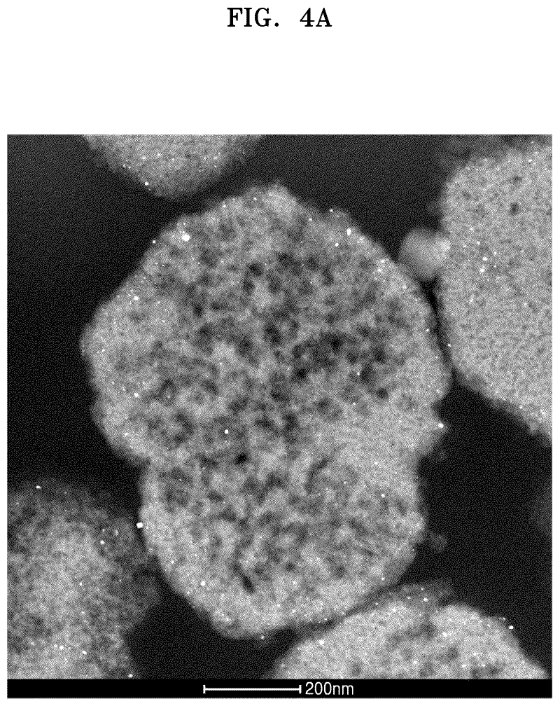

The composite catalyst may include the support, the support may include the amorphous aluminosilicate, and the amorphous aluminosilicate may be, for example, a porous amorphous aluminosilicate. For example, the support may be porous. The porous amorphous aluminosilicate may include a plurality of pores (e.g., pores), and the plurality of pores may be irregularly or non-periodically disposed within the amorphous aluminosilicate. For example, referring to FIG. 4A, the porous amorphous aluminosilicate (e.g., porous amorphous aluminosilicate particle) may include a plurality of pores disposed within the amorphous aluminosilicate (e.g., amorphous aluminosilicate particle), and the plurality of pores may be irregularly or non-periodically within the amorphous aluminosilicate particle.

The porous amorphous aluminosilicate may contain, for example, a mesopore. The mesopore may refer to a pore with a size of about 2 nm to about 50 nm. A volume of the mesopore may be about 20 vol % to about 80 vol %, 30 vol % to about 80 vol %, 40 vol % to about 80 vol %, 50 vol % to about 80 vol %, or about 60 vol % to about 80 vol %, with respect to a total volume of the pores in the porous amorphous aluminosilicate. With the volume of the mesopore in the aforementioned ranges, the composite catalyst may show a further improved ability to remove volatile organic compounds. The average size of the mesopore may be, for example, about 3 nm to about 50 nm, about 3 nm to about 40 nm, about 3 nm to about 30 nm, about 4 nm to about 20 nm, about 5 nm to about 15 nm, or about 10 nm to about 15 nm. With the mesopore having an average size in the aforementioned ranges, the composite catalyst may effectively remove volatile organic compounds having increased sizes. The size of mesopore may be measure by methods, such as a nitrogen adsorption method, a mercury intrusion porosimetry technique, or the like.

Because a size of the pores disposed in the amorphous aluminosilicate is greater than a size of pores disposed in the crystalline aluminosilicate in the composite catalyst, transfer of materials with an increased size may be further facilitated through the pores having an increased size. Therefore, removal of volatile organic compounds having an increased size may be facilitated. With the first particle supported on the support, the composite catalyst may further promote the decomposition of volatile organic compounds. Consequently, the composite catalyst may remove volatile organic compounds more effectively. For example, the removal reaction rate of volatile organic compounds may increase. For example, the temperature at which volatile organic compounds are 100% converted to carbon dioxide may be decreased.

The porous amorphous aluminosilicate may further include a micropore in addition to the mesopore. The porous amorphous aluminosilicate may include the micropore and the mesopore. The micropore may refer to a pore having a size of less than 2 nm. In a pore size distribution diagram of the porous amorphous aluminosilicate as obtained by a nitrogen adsorption method, the pore volume of the mesopore may be greater than the pore volume of the micropore. In the total pore volume of pores included in the porous amorphous aluminosilicate, a first pore volume occupied by the mesopore may be greater than a second pore volume occupied by the micropore. In the total pore volume of pores included in the porous amorphous aluminosilicate, the first pore volume occupied by the mesopore may be greater than about 100%, about 110% or greater, about 120% or greater, about 150% or greater, or about 200% or greater, with respect to the second pore volume occupied by the micropore. In the total pore volume of pores included in the porous amorphous aluminosilicate, the first pore volume occupied by the mesopore may be greater than about 100% to about 1,000%, about 110% to about 500%, about 120% to about 400%, about 150% to about 300%, or about 200% to about 300%, with respect to the second pore volume occupied by the micropore. With the porous amorphous aluminosilicate having the first pore volume in the aforementioned ranges, the composite catalyst may have a further improved ability to remove volatile organic compounds.

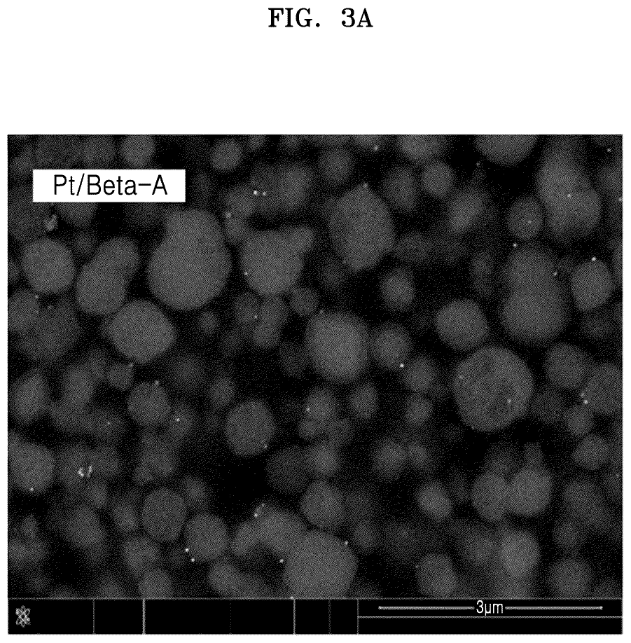

Referring to FIG. 2, in a pore size distribution diagram of the porous amorphous aluminosilicate obtained by a nitrogen adsorption method, the maximum value of differential pore volume of the mesopore may be about 0.1 cubic centimeter per gram (cm³/g) or greater, about 0.11 cm³/g or greater, or about 0.12 cm³/g or greater. In the pore size distribution diagram of the porous amorphous aluminosilicate obtained by a nitrogen adsorption method, the maximum value of differential pore volume of the mesopore having a size of about 5 nm to about 50 nm, or about 3 nm to about 50 nm, may be about 0.1 cm³/g or greater, about 0.11 cm³/g or greater, or about 0.12 cm³/g or greater. Because the maximum value of the differential pore volume of the mesopore in the pore size distribution diagram of the porous amorphous aluminosilicate obtained by a nitrogen adsorption method is within the aforementioned ranges, the composite catalyst may have a further improved ability to remove volatile organic compounds.

The composite catalyst may include the support and the first particle supported on the support, and the first particle may include a metal, a metal oxide, or a combination thereof. The first particle may include the metal. The metal may include, for example, an element of Groups 2 to 16 of the Periodic Table of the Elements, or a combination thereof. The metal may include Pt, Pd, Ru, V, Ag, Mn, Ni, Zn, Co, Ce, Ti, Al, Fe, Ni, Na, In, Bi, W, Sn, or a combination thereof. The metal may include Pt, for example. The first particle may include the metal oxide. The metal oxide may be, for example, represented by MₐO_{b} (0<a≤4, 0<b≤5, and M is an element of Groups 2 to 16 of the Periodic Table of the Elements, or a combination thereof). The metal oxide may be, for example, PtOₓ (0<x≤2), PdO_{y} (0<x≤1), RuOₓ (0<x≤2), V₂Oₓ (0<x≤5), Ag₂Oₓ (0<x≤1), MnOₓ (0<x≤2), CoₓO_{y} (0<x≤3, 0<y≤4), CeOₓ (0<x≤2), TiOₓ (0<x≤2), MnOₓ—TiO_{y} (0<x≤2, 0<y≤2), AlₓO_{y} (0<x≤2, 0<y≤3), FeₓO_{y} (0<x≤2, 0<y≤3), NiOₓ (0<x≤1), MnOₓ—Mn_{y}O_{z} (0<x≤2, 0<y≤3, 0<z≤4), NaInOₓ (0<x≤2), BiₓWO_{y} (0<x≤2, 0<y≤6), SnOₓ (0<x≤2), or a combination thereof. The metal oxide may include, for example, PtO₂, PdO, RuO₂, V₂O₅, VO₂, V₂O₃, Ag₂O, MnO₂, Mn₃O₄, MnO₂—Mn₃O₄, NiO, ZnO, ZnO₂, Co₃O₄, CeO₂, TiO₂, MnO₂—TiO₂, Al₂O₃, Fe₂O₃, NaInO₂, Bi₂WO₆, SnO₂, or a combination thereof.

The first particle may be non-homogeneously supported on the support. The support may include an inner portion and an outer portion. The inner portion of the support may be defined, for example, by a second distance, which is a distance between a point corresponding to 80% of a first distance and a geometric center of the support, wherein the first distance is a distance between the geometric center of the support and a surface of the support. The outer portion of the support may be disposed on the inner portion of the support. The outer portion of the support may be defined by a third distance, which is a distance between a point corresponding to 80% of the first distance, e.g., the surface of the inner portion, and the surface of the support. The first particle may be optionally supported on a portion of the support. All or part of the first particle may be optionally disposed in the outer portion of the support. With the first particle optionally disposed in the outer portion of the support, the composite catalyst may have a further improved performance (e.g., rate) of removal of volatile organic compounds.

In an aspect, the composite catalyst comprises the first particle non-homogeneously disposed on the support, wherein the support has a first distance from the geometric center of the support to a surface of the support, a second distance from a geometric center of the support to a point corresponding to 80% of the first distance, and a third distance from the surface of the support to the point corresponding to 80% of the first distance from the geometric center of the support, and wherein the support comprises an inner portion defined by the second distance, and an outer portion defined by the third distance, and wherein an amount of the first particle disposed in the outer portion is greater than an amount of the first particle disposed in the inner portion.

Referring to FIG. 4A, an amount of the first particle disposed in the outer portion of the support may be greater than an amount of the first particle disposed in the inner portion of the support. The amount of the first particle disposed in the outer portion of the support to the amount of the first particle disposed in the inner portion of the support may be greater than about 100%, about 110% or greater, about 120% or greater, about 150% or greater, or about 200% or greater. The amount of the first particle disposed in the outer portion of the support to the amount of the first particle disposed in the inner portion of the support may be greater than about 100% to about 500%, about 110% to about 500%, about 120% to about 500%, about 150% to about 400%, or about 200% to about 300%. Because the amount of the first particle disposed in the outer portion of the support is greater than the amount of the first particle disposed in the inner portion of the support, the composite catalyst may have a further improved performance of removal of volatile organic compounds.

A size of the first particle may be, for example, about 0.1 nm to about 10 nm, about 0.1 nm to about 7 nm, about 0.5 nm to about 5 nm, or about 1 nm to about 5 nm. In some embodiments, the size of the first particle may be, for example, about 0.1 nm to about 10 nm, about 0.1 nm to about 5 nm, about 0.1 nm to about 3 nm, or about 0.1 nm to about 2 nm. With the first particle having a size in the aforementioned ranges, the composite catalyst may have a further increased effective contact area with a volatile organic compound. Consequently, the composite catalyst may have a further improved performance of removal of volatile organic compounds. The composite catalyst may be free of a first particle having a size of about 100 nm or greater, about 50 nm or greater, or about 30 nm or greater. For example, the support may not include the first particle having a size of about 100 nm or greater, for example, about 100 nm to about 10 μm. In an aspect, the composite catalyst comprises 0 weight percent to about 0.01 weight percent, about 0.0001 weight percent to about 0.005 weight percent, about 0.0005 weight percent to about 0.001 weight percent, of the first particle having a size of about 100 nm or greater, with respect to a total weight of the composite catalyst. Because the composite catalyst does not include the first particle having a size of about 100 nm or greater that are formed due to agglomeration of a plurality of metal ions and/or metal particles, non-uniformity in catalyst reactions may be suppressed. The size of the first particle may be, for example, a diameter of a primary particle measured from a scanning electron microscope image or a transmission electron microscope image. The size of the first particle may be, for example, an average particle diameter. The average particle diameter may be measured, for example, by a measurement device using a laser diffraction technique or a dynamic light scattering technique. The average particle diameter is measured using, for example, a laser scattering particle size distribution system (e.g., LA-920 Horiba), and the average particle diameter may be a value of median particle diameter (D50) at 50% from the smallest particle based on volume on a cumulative particle distribution.

The amount of the first particle may be about 0.1 weight percent (wt %) to about 5 wt %, about 0.1 wt % to about 4 wt %, about 0.1 wt % to about 3 wt %, about 0.1 wt % to about 2 wt %, or about 0.1 wt % to about 1 wt %, with respect to a total weight of the composite catalyst. With the first particle in an amount in the aforementioned ranges, the composite catalyst may show further improved removal performance for volatile organic compounds. If the amount of the first particle is excessively low, the expected effect may be insignificant. If the amount of the first particle is excessively high, the increase in catalytic effect due to an increased amount may be insignificant.

An unpurified air stream may contain a first compound, and the first compound may include, for example, a volatile organic compound (VOC). The VOC is not particularly limited and may include any or all volatile organic compounds that are regarded as harmful to the human body or to the environment in the industry locally or overseas. The VOC may include, for example, a polar compound, a nonpolar compound, or a combination thereof.

The VOC may be, for example, a nonpolar compound. The nonpolar compound may include, for example, an aliphatic hydrocarbon, an aromatic hydrocarbon, or a combination thereof. The aliphatic hydrocarbon and the aromatic hydrocarbon may be unsubstituted, or may be substituted with a substituent group. The substituent group may be, for example, an alkyl group, an alkenyl group, an alkynyl group, a cycloalkyl group, an aryl group, a heteroaryl group, an aralkyl group, a cycloalkenyl group, a heterocyclic group, a halogen, or the like. The aliphatic hydrocarbon may include, for example, methane, ethane, propane, butane, pentane, hexane, or a combination thereof. The aromatic hydrocarbon may include, for example, benzene, toluene, xylene, or a combination thereof.

The VOC may be, for example, a polar compound. The polar compound may include, for example, ammonia (NH₃), an amine compound, an aldehyde compound, a ketone compound, an alcohol compound, a sulfur compound, a thiol compound, a halogenated hydrocarbon, a nitrogen oxide (NOₓ), a sulfur oxide (SOₓ), ozone, or a combination thereof. The amine compound may include, for example, methylamine, dimethylamine, trimethylamine, ethylamine, aniline, or a combination thereof. The aldehyde compound may include, for example, formaldehyde, acetaldehyde, propiolaldehyde, butyraldehyde, or a combination thereof. The ketone compound may include, for example, dimethyl ketone, methyl ethyl ketone, diethyl ketone, methyl propyl ketone, dipropyl ketone, or a combination thereof. The alcohol compound may include, for example, methanol, ethanol, propanol, isopropanol, butanol, pentanol, hexanol, heptanol, or a combination thereof. The sulfur compound may include, for example, hydrogen sulfide, sulfur dioxide, elemental sulfur, sulfur oxide (SOₓ), or a combination thereof. The thiol compound may include, for example, methanethiol, ethanethiol, propanethiol (e.g., 1-propanethiol, 2-propanethiol), butanethiol, tert-butyl mercaptan, thiophenol, or a combination thereof.

The composite catalyst may further include a solid substrate. The composite catalyst may include, for example, a solid substrate, and a support disposed on the solid substrate. The solid substrate is not limited to any particular material and may be formed of, for example, a polymer, a ceramic, a metal, or the like. The solid substrate is not limited to any particular form, and may be in the form of a mesh, a foam, a woven fabric, a non-woven fabric, a honeycomb structure, or the like. The support and the solid substrate may be disposed, for example, across an air stream and between an upstream of the air stream and a downstream of the air stream. For example, the air stream may be arranged such that the air stream sequentially passes through one side of the support and the solid substrate and then the other side opposing the one side. The support may be positioned upstream of the air stream, relative to the solid substrate. For example, the support may be positioned such that the support comes in contact with the air stream before the solid substrate does. In some embodiments, the support and the solid substrate may be disposed along the air stream, for example, from the upstream of the air stream toward the downstream of the air stream. For example, the air stream may be positioned such that the air stream moves along one side of the support and the solid substrate, and/or the other side opposing the one side. The support may have the first particle supported thereon. The composite catalyst including the solid substrate and the support disposed on the solid substrate may form, for example, a catalytic filter.

In another embodiment, an air purification device may include a housing and the composite catalyst, wherein the composite catalyst is disposed within the housing. By including the composite catalyst disposed within the housing, the air purification device may purify unpurified air more easily. The housing is not limited to any particular form, and may utilize any suitable form capable of accommodating the composite catalyst therein. The air purification device may include, for example, the housing and the catalytic filter disposed within the housing. The catalytic filter may comprise the composite catalyst including the solid substrate and the support that is disposed on the solid substrate and has the first particle supported thereon. The housing is not limited to any particular form, and may include an air inlet and an air outlet, wherein the composite catalyst is disposed between the air inlet and the air outlet.

The composite catalyst, for example, provided in a form of a catalytic filter, may be mounted on various indoor and outdoor air purification devices, such as air purifiers, air purification facilities, and air conditioning equipment, to remove volatile organic compounds or fine particles from unpurified air. The composite catalyst may also be applied to air purification devices and air purification systems to remove odorous substances, germs, pathogens, bacteria, and the like, as well as volatile organic compounds.

For example, the catalytic filter, which has the composite catalyst disposed on the solid substrate, may be provided.

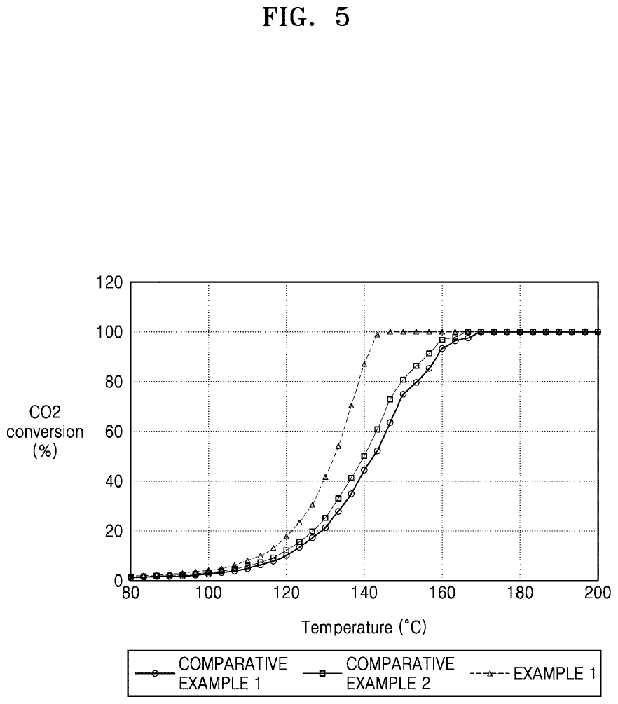

According to an example embodiment, a catalytic filter and an air purification system including the catalytic filter are described in greater detail with reference to FIGS. 6 to 10.

Referring to FIG. 6, a catalytic filter 100 may include an inflow side through which unpurified air 130 is introduced, and an outflow side through which purified air 140 is discharged. The unpurified air 130 may include one or more first compounds.

The unpurified air 130 may include, for example, a particulate first compound, a gaseous first compound, or a combination thereof. The catalytic filter 100 may have a thickness T1 defined by a direction that extends from the inflow side to the outflow side (direction of Y-axis in FIG. 6).

The catalytic filter 100 may include a plurality of first recessed portions 110, each of which has an entrance portion located adjacent to the inflow side through which the unpurified air 130 is introduced, and has a bottom portion located adjacent to the outflow side through which the purified air 140 is discharged. The unpurified air 130 may be introduced into the catalytic filter 100 through the plurality of first recessed portions 110. The plurality of first recessed portions 110 may be arranged regularly and/or periodically. The plurality of first recessed portions 110 may be, for example, arranged in parallel to one another along the direction of X-axis and/or the direction of Z-axis in FIG. 6.

The catalytic filter 100 may include a plurality of first surfaces 120S exposed on the inflow side through which the unpurified air 130 is introduced. The plurality of first surfaces 120S may be arranged regularly and/or periodically. The plurality of first surfaces 120S may be, for example, disposed among the plurality of first recessed portions 110.

The plurality of first surfaces 120S may be, for example, spaced apart from one another while being disposed among the plurality of first recessed portions 110 that are spaced apart from one another along a first direction along the inflow side, for example, along the direction of X-axis and/or the direction of Z-axis in FIG. 6. In the first direction along the inflow side, for example, along the direction of X-axis and/or the direction of Z-axis in FIG. 6, the plurality of first surfaces 120S and the plurality of first recessed portions 110 may be arranged in an alternating fashion. One first recessed portion 110 may be surrounded by four first surfaces 120S, and one first surface 120S may be surrounded by four first recessed portions 110.

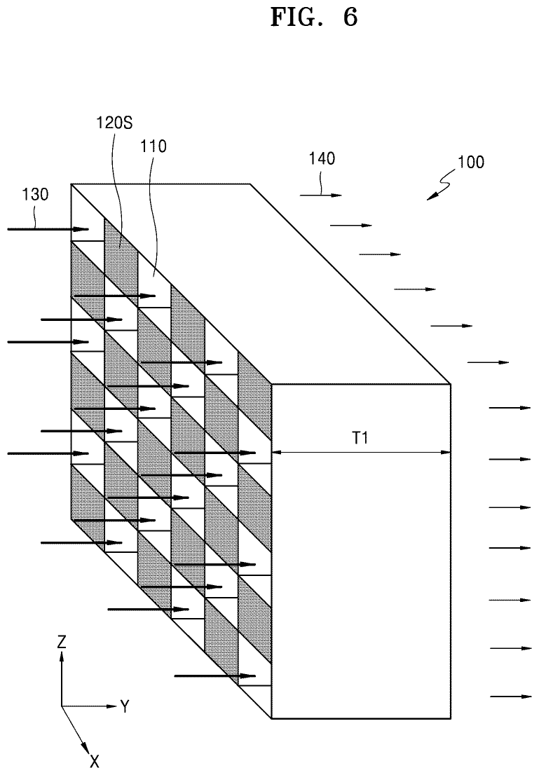

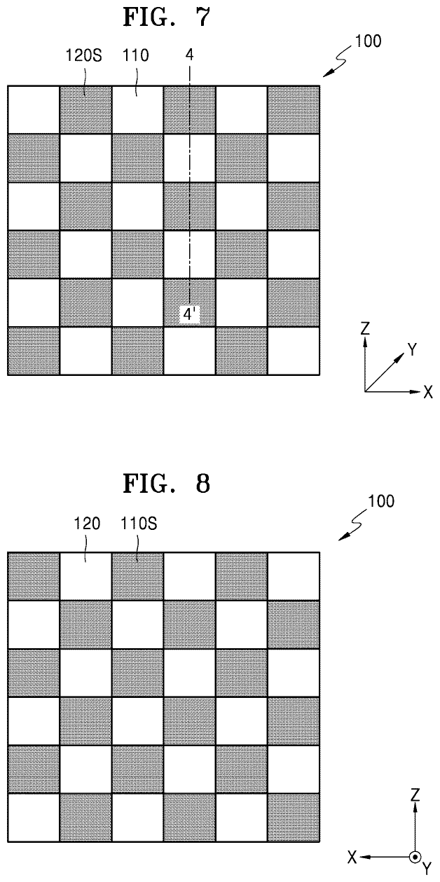

FIG. 7 is a front view of a front side, i.e., an inflow side, of the catalytic filter 100 in FIG. 6. FIG. 8 is a front view of a rear side, i.e., an outflow side, of the catalytic filter 100 in FIG. 7.

Referring to FIG. 7, the inflow side of the catalytic filter 100 may include a plurality of first recessed portions 110 and a plurality of first surfaces 120S.

Referring to FIG. 8, the outflow side of the catalytic filter 100 may include a plurality of second recessed portions 120 and a plurality of second surfaces 110S. The plurality of second recessed portions 120 may be an outlet from which purified air is discharged. The purified air discharged through the second recessed portions 120 may be air obtained by removing the first compounds from the unpurified air 130 introduced through the first recessed portions 110, or may be air containing harmless gases obtained by breaking down the first compounds.

The plurality of second recessed portions 120 may be regularly and/or periodically arranged along the direction of X-axis and/or the direction of Z-axis in FIG. 8. The plurality of second surfaces 110S may be regularly arranged. The plurality of second surfaces 110S may be disposed between the plurality of second recessed portions 120.

The plurality of second surfaces 110S may correspond to the plurality of first recessed portions 110, and the plurality of second recessed portions 120 may correspond to the plurality of first surfaces 120S.

Referring to FIGS. 6 and 8, a second surface 110S may serve as the rear portion of a first recessed portion 110, and a first surface 120S may correspond to the rear portion of a second recessed portion 120.

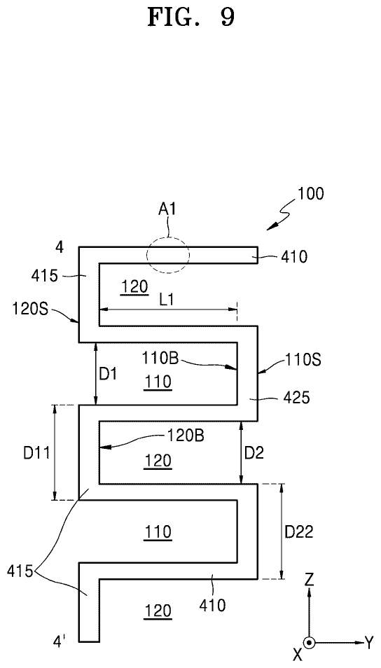

FIG. 9 is a cross-sectional view taken through line 4-4′ as indicated in in FIG. 6.

The catalytic filter 100 may be a single-body structure, or a single-body frame. The catalytic filter 100 may have a frame that is entirely formed of one material, for example, a ceramic material, a polymer material, a metal material, or the like. The catalytic filter 100 may have, for example, a single-body structure or a monolithic structure, where the entire structure is connected as a single unit. Alternatively, the catalytic filter 100 may be a multilayer structure or a multilayer frame. Although not illustrated in the drawings, the catalytic filter 100 may have, for example, a multilayer structure including a solid substrate and an organic/inorganic composite catalyst disposed on the solid substrate. Referring to FIG. 9, the catalytic filter 100 may be a structure having a frame in which a plurality of first recessed portions 110 and second recessed portions 120 are sequentially arranged along the direction of Z-axis. The catalytic filter 100 may include a plurality of horizontal areas 410 and a plurality of vertical areas 415, 425. The plurality of horizontal areas 410 may be spaced apart from one another along the direction of Z-axis. The direction of Z-axis corresponds to a vertical direction. The plurality of horizontal areas 410 may be arranged in parallel to one another along the direction of Y-axis. The plurality of horizontal areas 410 may have the same length or a different length from one another. The plurality of horizontal areas 410 may be disposed between the plurality of vertical areas 415 and 425. The plurality of horizontal areas 410 may be physically connected to one another through the plurality of vertical areas 415 and 425. The plurality of vertical areas 415 and 425 may be arranged in parallel to one another, and spaced apart from one another. The plurality of vertical areas 415 and 425 may be spaced apart from one another along the direction of Z-axis. The plurality of vertical areas 415 and 425 may be arranged in parallel to one another along the direction of Y-axis. The plurality of vertical areas 415 and 425 may have the same length or a different length from one another. The plurality of vertical areas 415 and 425 may be disposed between the plurality of horizontal areas 410. The plurality of vertical areas 415 and 425 may be physically connected to one another through the plurality of horizontal areas 410. The plurality of vertical areas 415 and 425 may include a plurality of first vertical areas 415 and a plurality of second vertical areas 425. The plurality of first vertical areas 415 and the plurality of second vertical areas 425 may be spaced apart from one another along the direction of Y-axis. The plurality of first vertical areas 415 may be spaced apart from one another along the direction of Z-axis. The plurality of second vertical areas 425 may be spaced apart from one another along the direction of Z-axis. The plurality of first vertical areas 415 may be disposed on the inflow side to which the unpurified air 130 is supplied. The plurality of second vertical areas 425 may be disposed on the outflow side from which the purified air 140 is discharged.

The plurality of horizontal areas 410 may correspond to walls of the first recessed portion 110 and second recessed portion 120. The plurality of horizontal areas 410 may be located between the first recessed portion 110 and the second recessed portion 120, thereby serving as boundaries of each of the first and second recessed portions 110 and 120. The walls may correspond to sidewalls of the first recessed portion 110 and the second recessed portion 120. The plurality of horizontal areas 410 may have the same thickness or a different thickness with each other. The plurality of horizontal areas 410 may have the same thickness as or a different thickness from a thickness of the plurality of vertical areas 415 and 425. Thus, each of the plurality of the horizontal areas 410, and each of the plurality of the vertical areas 415 and 425 may have any suitable thickness. The horizontal areas 410 that serve as the walls of the first recessed portion 110 may be spaced apart from each other by a first distance D1 along the direction of Z-axis. The horizontal areas 410 that serve as the walls of the second recessed portion 120 may be spaced apart from each other by a second distance D2 along the direction of Z-axis. The first distance D1 and the second distance D2 may be the same or different from each other. The opening of the first recessed portion 110 and the opening of the second recessed portion 120 may have the same or a different width and/or surface area with each other. A Y-axis length L1 of each of the plurality of horizontal areas 410 may be the same or different from one another. The depth of a first recessed portion 110 and a second recessed portion 120 may be defined by the Y-axis length L1 of a horizontal area 410. The first recessed portion 110 and the second recessed portion 120 may have the same depth or a different depth with each other. The plurality of first vertical areas 415 may form the rear portions of the second recessed portions 120. The plurality of second vertical areas 425 may form the rear portions of the first recessed portions 110. The rear portions of the first recessed portions 110 and the rear portions of the second recessed portions 120 may have the same or a different air permeability with each other. A third distance D11 of a first vertical area 415 and a fourth distance D22 of a second vertical area 425 may be the same or different from each other. The first vertical area 415 and the second vertical area 425 may have the same depth or a different depth with each other along the direction of Y-axis.

The plurality of horizontal areas 410 and the plurality of vertical areas 415 and 425 may be formed of the same material and may have a single-body or monolithium structure where the entire structure is connected as a single unit.

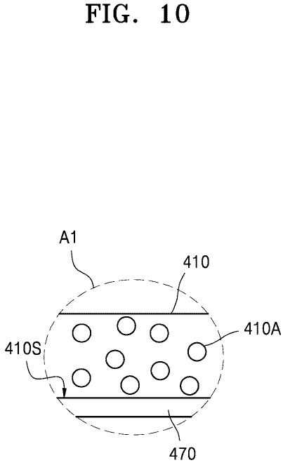

FIG. 10 is an expanded view of a first area Al of a horizontal area 410 in FIG. 9.

Referring to FIG. 10, the horizontal area 410 may include a pore 410A. The vertical areas 415, 425 may contain pores or may not contain pores.

The horizontal area 410 and the vertical areas 415 and 425 may include pores, and a pore density of the vertical areas 415 and 425 may be greater or less than a pore density of the horizontal area 410.

For example, the first vertical area 415 may include pores, and the second vertical area 425 may not include pores. Alternatively, the first vertical area 415 may not include pores, and the second vertical area 425 may include pores.

The first vertical area 415 and the second vertical area 425 may include pores, and a pore density of the second vertical area 425 may be greater or less than a pore density of the first vertical area 415.

A catalyst layer 470 including a composite catalyst may be disposed on one surface 410S of the horizontal area 410. The catalyst layer 470 may be disposed, for example, in both the horizontal areas 410 and the vertical areas 415 and 425.

A method of preparing the composite catalyst according to another embodiment may include: providing an aluminosilicate (e.g., a bare aluminosilicate); preparing alkali-treated aluminosilicate by contacting the bare aluminosilicate with an alkaline solution; preparing a heat-treated porous aluminosilicate by performing a first heat-treatment on the alkali-treated aluminosilicate; preparing acid-treated aluminosilicate by contacting the heat-treated aluminosilicate with a strong acid; preparing aluminosilicate with a precursor of a first particle supported thereon, by contacting the acid-treated aluminosilicate with a precursor solution of the first particle; and preparing a composite catalyst by performing a second heat-treatment on the aluminosilicate with the precursor of the first particles supported thereon.

In an aspect, a method preparing a composite catalyst comprises:
providing an aluminosilicate;
contacting the aluminosilicate and an alkaline solution to prepare an alkali-treated aluminosilicate;
performing a first heat-treatment on the alkali-treated aluminosilicate to prepare a heat-treated porous aluminosilicate;
contacting the heat-treated porous aluminosilicate and a strong acid to prepare an acid-treated aluminosilicate;
contacting the acid-treated aluminosilicate and a precursor solution of a first particle to prepare an aluminosilicate having a precursor of the first particle supported thereon; and performing a second heat-treatment on the aluminosilicate having the precursor of the first particle supported thereon to prepare the composite catalyst.

The composite catalyst prepared by the aforementioned method may provide an improved ability to remove volatile organic compounds.

First, bare aluminosilicate may be provided. The bare aluminosilicate may be, for example, a zeolite. The zeolite is not limited to any particular type and may be any suitable type of zeolite. The zeolite may be, for example, p-zeolite, ZSM-5, FAU, MFI, BEA, MOR, or the like, but without being limited thereto, may utilize any zeolite available in the art.

Next, the alkali-treated aluminosilicate may be prepared by bringing the bare aluminosilicate into contact with an alkaline solution. The alkaline solution may be an alkaline aqueous solution. A concentration of the alkaline solution may be, for example, about 0.01 molar (M) or greater, or about 0.05 M or greater. The concentration of the alkaline solution may be, for example, about 0.01 M to about 0.5 M, or about 0.05 M to about 0.3 M. The alkaline solution may include, for example, an alkaline compound. The alkaline compound may be, for example, NaOH, KOH, RbOH, CsOH, or the like, but without being limited thereto, and may utilize any suitable alkaline compound available in the art. A temperature at which the contacting the bare aluminosilicate and the alkaline solution may be, for example, about 20° C. to about 100° C., about 20° C. to about 50° C., or about 20° C. to about 40° C. A contact time between the bare aluminosilicate and the alkaline solution may be, for example, from about 1 minute to about 24 hours, from about 5 minutes to about 12 hours, from about 10 minutes to about 6 hours, from about 10 minutes to about 2 hours, or from about 10 minutes to about 1 hour. By contacting the bare aluminosilicate with the alkaline solution, a porous aluminosilicate with an increased pore size may be prepared.

Next, contacting the alkali-treated aluminosilicate with an ammonium salt-containing solution to allow ion-exchange reactions to occur may be further included. The ammonium salt may be, for example, an ammonium nitrate, an ammonium sulfate, an ammonium hydrochloride, or the like, but without being limited thereto, any suitable ammonium salt available in the art may be used. A concentration of the ammonium salt-containing solution may be, for example, about 0.1 M to about 5 M, about 0.1 M to about 3 M, or about 0.5 M to about 2 M. A temperature at which the contacting the alkali-treated aluminosilicate and the ammonium salt-containing solution may be, for example, about 50° C. to about 100° C., about 70° C. to about 100° C., or about 70° C. to about 90° C. A contact time between the alkali-treated aluminosilicate and the ammonium salt-containing solution may be, for example, about 30 minutes to about 24 hours, about 30 minutes to about 12 hours, about 30 minutes to about 6 hours, or about 30 minutes to about 2 hours.

Next, heat-treated porous aluminosilicate may be prepared by performing a first heat-treatment on the alkali-treated aluminosilicate. The alkali-treated aluminosilicate may be washed with distilled water a few times before performing the first heat-treatment. The first heat-treatment may be performed at a temperature of, for example, about 400° C. to about 900° C., about 400° C. to about 700° C., or about 500° C. to about 600° C. The first heat-treatment may be performed, for example, in an oxidizing atmosphere or an inert atmosphere, for about 1 hour to about 24 hours, about 2 hours to about 12 hours, or about 3 hours to about 6 hours. The inert atmosphere may include, for example, a nitrogen atmosphere, an argon atmosphere, or a combination thereof. The oxidizing atmosphere may include, for example, an oxygen atmosphere, an air atmosphere, or the like.

Next, acid-treated aluminosilicate may be prepared by bringing the heat-treated aluminosilicate into contact with a strong acid. The strong acid may include nitric acid, hydrochloric acid, sulfuric acid, or a combination thereof, but without being limited thereto, and any suitable strong acid available in the art may be used. The strong acid may be, for example, a mixture of hydrochloric acid and nitric acid in a ratio of about 3:1. The strong acid may be, for example, a solution containing a strong acid. A pH of the strong acid may be, for example, less than about 1, less than about 0.5, or less than about 0.1. The pH of the strong acid may be, for example, in a range of about 0 to less than 1, about 0 to about 0.5, or about 0 and about 0.1. In an aspect, organic acids, such as acetic acid, oxalic acid, and formic acid, are not strong acids. The temperature of the strong acid, i.e., the temperature at which the heat-treated aluminosilicate is brought into contact with the strong acid, may be, for example, about 20° C. to about 200° C., about 50° C. to about 150° C., or about 70° C. to about 90° C. A contact time between the heat-treated aluminosilicate and the strong acid may be, for example, about 1 hour to about 48 hours, about 6 hours to about 36 hours, or about 12 hours to about 48 hours.

Next, aluminosilicate with a precursor of the first particle supported thereon may be prepared by bringing the acid-treated aluminosilicate into contact with a precursor solution of the first particle. The acid-treated aluminosilicate may not undergo washing or heat treatment prior to bringing the acid-treated aluminosilicate into contact with the precursor solution of the first particles. By bringing the acid-treated aluminosilicate in contact with the precursor solution of the first particle without any additional washing or heat-treatment, the first particle having a small size may be more uniformly distributed on the surface of the acid-treated aluminosilicate without agglomeration. The precursor solution of the first particle may be a precursor solution of a metal included in the first particle. An amount of the precursor of the first particle may be about 0.1 parts by weight to about 5 parts by weight, about 0.1 parts by weight to about 3 parts by weight, or about 0.1 parts by weight to about 1 part by weight, with respect to 100 parts by weight of the acid-treated aluminosilicate. The precursor of the first particle may be a metal salt. The metal salt may be, for example, a salt including an element of Groups 2 to 16 of the Periodic Table of the Elements, or a combination thereof. The metal salt may be, for example, a salt including Pt, Pd, Ru, V, Ag, Mn, Ni, Zn, Co, Ce, Ti, Al, Fe, Ni, Na, In, Bi, W, Sn, or a combination thereof. The metal salt may be, for example, a halogen salt, a nitrate, a carbonate, a phosphate, a sulfate, or the like, but is not limited thereto. Methods of having a metal salt supported on the acid-treated aluminosilicate may include, for example, incipient-wetness impregnation, deposition precipitation, coprecipitation, wet impregnation, sputtering, gas-phase grafting, liquid-phase grafting, and the like. The incipient-wetness impregnation is also known as dry impregnation. For example, the incipient-wetness impregnation method may be used.

Finally, the aluminosilicate with the precursor of the first particle supported thereon may be subjected to a second heat-treatment to prepare the composite catalyst. The second heat-treatment may be performed at a temperature of, for example, about 400° C. to about 900° C., about 400° C. to about 700° C., or about 500° C. to about 600° C. The second heat-treatment may be performed, for example, in an oxidizing atmosphere or an inert atmosphere, for about 1 hour to about 24 hours, about 2 hours to about 12 hours, or about 3 hours to about 6 hours. The inert atmosphere may include, for example, a nitrogen atmosphere, an argon atmosphere, or a combination thereof. The oxidizing atmosphere may include, for example, an oxygen atmosphere, an air atmosphere, or the like. For example, the temperature of the second heat-treatment may be greater than the temperature of the first heat-treatment. The temperature of the second heat-treatment may be greater than the temperature of the first heat-treatment by about 10° C. or greater, about 20° C. or greater, about 30° C. or greater, or about 40° C. or greater, in an aspect, by about 10° C. to about 580° C. As the temperature of the second heat-treatment is greater than the temperature of the first heat-treatment, the composite catalyst may have a further improved ability to remove volatile organic compounds.

In the present specification, a substituent group may be introduced as at least one hydrogen in an unsubstituted mother group is replaced with another atom or functional group. Unless otherwise indicated, when a functional group is considered to be “substituted”, it means that the functional group is substituted with at least one substituent group selected from a C₁-C₄₀ alkyl group, a C₂-C₄₀ alkenyl group, a C₂-C₄₀ alkynyl group, a C₃-C₄₀ cycloalkyl group, a C₃-C₄₀ cycloalkenyl group, and a C₇-C₄₀ aryl group. When a functional group is described as being “optionally substituted”, this means that the functional group may or may not be substituted with any one of the aforementioned substituent groups.

As used herein, a and b in “Cₐ-C_{b}” represent the number of carbon atoms in a specific functional group. Here, the functional group may include a to b number of carbon atoms. For example, “C₁-C₄ alkyl group” refers to an alkyl group having 1 to 4 carbon atoms, such as CH₃—, CH₃CH₂—, CH₃CH₂CH₂—, (CH₃)₂CH—, CH₃CH₂CH₂CH₂—, CH₃CH₂CH(CH₃)—, and (CH₃)₃C—.

A particular radical may be called a mono-radical or a di-radical depending on the context. For example, when a substituent group needs two binding sites for binding with the rest of the molecule, the substituent may be understood as a di-radical. For example, a substituent group specified as an alkyl group that needs two binding sites may be a di-radical, such as —CH₂—, —CH₂CH₂—, and —CH₂CH(CH₃)CH₂—. The term “alkylene” as used herein clearly indicates that the radical is a di-radical.

The terms “alkyl group” and “alkylene group” as used herein refer to a branched or unbranched aliphatic hydrocarbon group. In an embodiment, the alkyl group may be substituted or unsubstituted. Examples of the alkyl group include, without being limited to a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, and a cycloheptyl group, each of which may be optionally substituted or unsubstituted. In an embodiment, the alkyl group may have 1 to 6 carbon atoms. For example, a C₁-C₆ alkyl group may be methyl, ethyl, propyl, isopropyl, butyl, iso-butyl, sec-butyl, pentyl, 3-pentyl, hexyl, or the like, without being necessarily limited thereto.

The term “alkenyl group” as used herein refers to a hydrocarbon group having 2 to 20 carbon atoms with at least one carbon-carbon double bond. Examples of the alkenyl group include an ethenyl group, a 1-propenyl group, a 2-propenyl group, a 2-methyl-1-propenyl group, a 1-butenyl group, a 2-butenyl group, a cyclopropenyl group, a cyclopentenyl group, a cyclohexenyl group, and a cycloheptenyl group. In an embodiment, the alkenyl group may be substituted or unsubstituted. In an embodiment, the alkenyl group may have 2 to 40 carbon atoms.

In this specification, the term “alkynyl group” refers to a C₂-C₂₀ hydrocarbon group including at least one carbon-carbon triple bond. Examples of the alkynyl group may include, but are not limited to an ethynyl group, a 1-propynyl group, a 1-butynyl group, and a 2-butynyl group. In an embodiment, the alkynyl group may be substituted or unsubstituted. In an embodiment, the alkynyl group may have 2 to 40 carbon atoms.

As used herein, the term “cycloalkyl group” refers to a fully saturated carbocyclic ring or ring system. For example, the cycloalkyl group may refer to cyclopropyl, cyclobutyl, cyclopentyl, or cyclohexyl.

The term “aromatic” as used herein refers to a ring or ring system with a conjugated n electron system, and may refer to a carbocyclic aromatic group (e.g., a phenyl group) and a heterocyclic aromatic group (e.g., pyridine). In this regard, an aromatic ring system as a whole may include a monocyclic ring or a fused polycyclic ring (i.e., a ring that shares adjacent atom pairs).

The term “aryl group” as used herein refers to an aromatic ring or ring system (i.e., a ring fused from at least two rings that shares two adjacent carbon atoms) having only carbon atoms in its backbone, or a plurality of aromatic rings that are linked by a single bond, —O—, —S—, —C(═O)—, —S(═O)₂—, —Si(Ra)(Rb)- (where Ra and Rb are each independently a C₁-C₁₀ alkyl group), a C₁-C₁₀ alkylene group unsubstituted or substituted with a halogen, or —C(═O)—NH—. If the aryl group is a ring system, each ring in the ring system is aromatic. Examples of the aryl group include a phenyl group, a biphenyl group, a naphthyl group, a phenanthrenyl group, and naphthacenyl group, but are not limited thereto. These aryl groups may be substituted or unsubstituted.

As used herein, the term “arylene group” refers to an aryl group that requires at least two linking sites, i.e., is at least divalent. A tetravalent arylene group may be an aryl group that requires four linking sites, and a divalent arylene group may be an aryl group that requires two linking sites. For example, the divalent arylene group may be —C₆H₅—O—C₆H₅— or the like.

As used herein, the term “heteroaryl group” refers to an aromatic ring system with one ring, a plurality of rings that are fused to each other, or an aromatic ring system having a plurality of rings that are linked by a single bond, —O—, —S—, —C(═O)—, —S(═O)₂—, —Si(Ra)(Rb)-(where Ra and Rb are each independently a C₁-C₁₀ alkyl group), a C₁-C₁₀ alkylene group unsubstituted or substituted with a halogen, or —C(═O)—NH—, in which at least one member of the aromatic ring system is a heteroatom, i.e., not carbon. In the fused ring system, at least one heteroatom may be present in only one ring. In the fused ring system, at least one heteroatom may be present in only one ring. For example, the heteroatom may be oxygen, sulfur, or nitrogen, but is not limited thereto. Examples of the heteroaryl group include, but are not limited to a furanyl group, a thienyl group, an imidazolyl group, a quinazolinyl group, a quinolinyl group, an isoquinolinyl group, a quinoxalinyl group, a pyridinyl group, a pyrrolyl group, an oxazolyl group, and an indolyl group.

As used herein, the term “heteroarylene group” may refer to a heteroaryl group that requires at least two linking sites. A tetravalent heteroarylene group may be a heteroaryl group that requires four linking sites, and a divalent heteroarylene group may be a heteroaryl group that requires two linking sites.

As used herein, the term “aralkyl group” or “arylalkyl group” refers to an aryl group linked to a substituent via an alkylene group, such as a C₇-C₁₄ aralkyl group. Non-limiting examples of the aralkyl group or arylalkyl group may include a benzyl group, a 2-phenylethyl group, a 3-phenylpropyl group, and a naphthylalkyl group. In one or more embodiments, the alkylene group may be a lower alkylene group (i.e., a C₁-C₄ alkylene group).

As used herein, the term “cycloalkenyl group” refers to a carbocyclic ring or ring system with at least one double bond without an aromatic ring. For example, the cycloalkenyl group may be a cyclohexenyl group.

As used herein, the terms “heterocyclic group” refers to a non-aromatic ring or ring system including at least one heteroatom in its cyclic backbone.

The term “halogen” as used herein refers to a stable element belonging to Group 17 of the periodic table, for example, fluorine, chlorine, bromine, or iodine. For example, the halogen may be fluorine and/or chlorine.

Weight average molecular weights of the first polymer, the second polymer, and the third polymer may be measured by gel permeation chromatography (GPC) with respect to a polystyrene standard sample.

Hereinafter, one or more embodiments will be described in greater detail with reference to the following examples. However, it will be understood that these examples are provided only to illustrate the present disclosure, and not intended to limit the scope of the one or more embodiments of the present specification.

### EXAMPLES

### Preparation of Composite Catalyst

### Example 1: Amorphous Aluminosilicate/Pt

β-zeolite was introduced in 0.2 M NaOH aqueous solution and stirred at 25° C. for 30 minutes, and the resulting product was separated, washed with distilled water a few times, and then dried. Alkali-treated aluminosilicate was prepared.

The alkali-treated aluminosilicate was introduced into 1 M NH₄NO₃ aqueous solution and stirred at 80° C. for 1 hour to allow ion-exchange reactions to occur, and the resulting product was separated, washed with distilled water a few times, and dried. The dried product was calcined in an inert atmosphere at 550° C. for 5 hours.

The dried product was added to a strong acid (HCl; HNO₃=1:3, aqua regia) solution and stirred at 80° C. for 24 hours, and the resulting product was separated, washed several times with distilled water, and then dried. Acid-treated aluminosilicate was prepared.

The acid-treated aluminosilicate was introduced into a 0.5 wt % H₂PtCl₆ solution, and a precursor was supported on the aluminosilicate by incipient-wetness impregnation or dry impregnation.

The aluminosilicate with the precursor supported thereon was calcined at 500° C. for 4 hours to prepare an aluminosilicate composite catalyst with Pt particles supported thereon.

### Example 2: Amorphous Aluminosilicate/Pt

A composite catalyst was prepared following the same process as Example 1 except that instead of β-zeolite, ZSM-5 was used as the starting material.

### Comparative Example 1: p-Zeolite/Pt

β-zeolite was introduced into a 0.5 wt % H₂PtCl₆ solution, and a precursor was supported on the β-zeolite by incipient-wetness impregnation or dry impregnation.

The β-zeolite with the precursor supported thereon was calcined at 500° C. for 4 hours to prepare a zeolite composite catalyst with Pt particles supported thereon.

### Comparative Example 2: Acid-Treated β-Zeolite/Pt

The β-zeolite was added to a strong acid (HCl; HNO₃=1:3, aqua regia) solution and stirred at 80° C. for 24 hours, and the resulting product was separated, washed several times with distilled water, and then dried. Acid-treated β-zeolite was prepared.

The acid-treated β-zeolite was introduced into a 0.5 wt % H₂PtCl₆ solution, and a precursor was supported on the β-zeolite by incipient-wetness impregnation or dry impregnation.

The β-zeolite with the precursor supported thereon was calcined at 500° C. for 4 hours to prepare an β-zeolite composite catalyst with Pt particles supported thereon.

### Comparative Example 3: ZSM-5/Pt

A composite catalyst was prepared following the same process as Comparative Example 1 except that instead of β-zeolite, ZSM-5 was used as the starting material.

### Comparative Example 4: ZSM-5/Pt

A composite catalyst was prepared following the same process as Comparative Example 2 except that instead of β-zeolite, ZSM-5 was used as the starting material.

### Preparation of Filters and Air Purification Devices

### Examples 3 and 4

The composite catalysts prepared in Examples 1 and 2 were each positioned on a porous support made of glass fibers, to thereby prepare a filter with a catalyst layer disposed on a porous solid substrate.

A tube having an inlet and an outlet was vertically placed, and the filter was placed between the inlet and the outlet, wherein while air is supplied through the inlet and discharged through the outlet, the filter was arranged such that the filter intersects the air stream moving from the inlet toward the outlet within the tube. The filter was installed in the tube such that an organic/inorganic composite catalyst be located in the upstream of the air stream relative to the porous support. The tube corresponds to a reaction chamber. The tube and the filter correspond to an air purification device.

### Comparative Examples 5 to 8

A filter and an air purification device were prepared following the same process as Example 3, except that the composite catalysts prepared in Comparative Examples 1 to 4 were respectively used.

### Evaluation Example 1: XRD Analysis

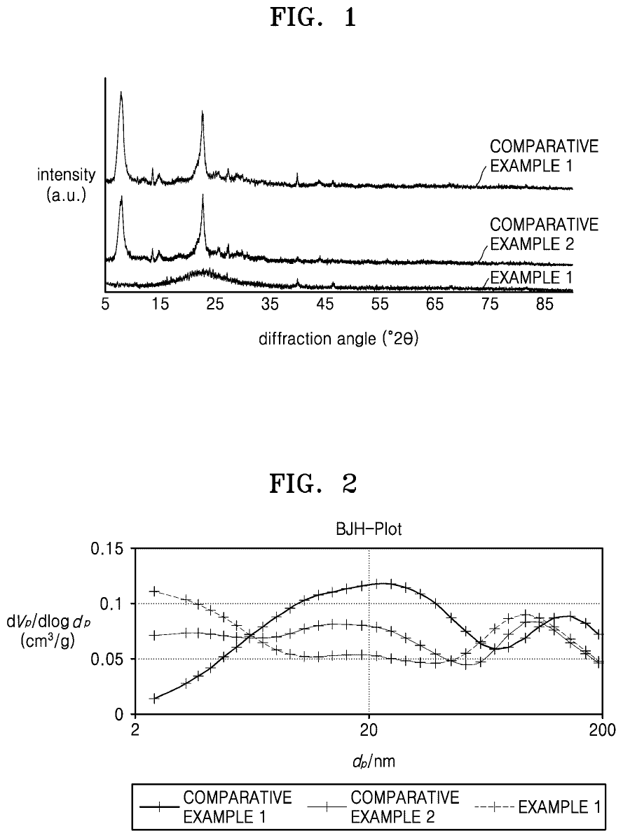

The composite catalyst powders prepared in Example 1 and Comparative Examples 1 and 2 were measured by XRD, and the measurement results are shown in FIG. 1.

As shown in FIG. 1, the composite catalysts prepared in Comparative Examples 1 and 2 showed both the presence of crystalline peaks at a diffraction angle 2θ=5° 2θ to 10° 2θ, and the presence of crystalline peaks at a diffraction angle 2θ=20° 2θ to 25° 2θ.

Meanwhile, the composite catalyst prepared in Example 1 did not show crystalline peaks originating from aluminosilicates, at a diffraction angle 2θ=5° 2θ to 30° 2θ. This result confirms that the aluminosilicate was amorphous.

The composite catalysts prepared in Example 1 and Comparative Examples 1 and 2 showed a plurality of crystalline peaks originating from Pt particles at a diffraction angle 2θ=40° 2θ to 57° 2θ.

As a result, in the composite catalyst prepared in Example 1, the intensity ratio (Ia/Ib) of a first peak intensity (Ia), which is a maximum peak intensity originating from the porous amorphous aluminosilicate, to a second peak intensity (Ib), which is a maximum peak intensity originating from the first particle, at a diffraction angle 2θ=5°2θ to 90° 2θ, was 0.

Meanwhile, in the composite catalysts prepared in Comparative Examples 1 and 2, the intensity ratio (Ia/Ib) of a first peak intensity (Ia), which is a maximum peak intensity originating from the porous amorphous aluminosilicate, to a second peak intensity (Ib), which is a maximum peak intensity originating from the first particle, at a diffraction angle 2θ=5° 2θ to 90° 2θ, was 5 or greater.

The degree of crystallinity of the composite catalyst prepared in Example 1 was 0%.

The degree of crystallinity ([Ac/(Aa+Ac)]×100) may be derived from the area under crystalline peaks (Ac) to the total sum of the area under amorphous peaks (Aa) and the area under crystalline peaks (Ac), as obtained from an XRD spectrum of the composite catalyst prepared in Example 1.

As shown in FIG. 1, the composite catalyst of Example 1 shows an area under amorphous peaks (Aa) but shows the area under crystalline peaks (Ac) of 0.

Meanwhile, the degree of crystallinity of each of the composite catalysts of Comparative Examples 1 and 2 was 100%.

### Evaluation Example 2: Brunauer-Emmett-Teller (BET) Analysis

The composite catalysts of Example 1, and Comparative Examples 1 and 2 were tested and measured for pore size distribution by a nitrogen adsorption test, and the measurement results are shown in FIG. 2.

As shown in FIG. 2, the composite catalyst of Example 1 was found to include mesopores having a diameter of 2 nm to 50 nm, and micropores having a diameter of less than 2 nm, wherein the volume of mesopores was greater than the volume of micropores.

It was confirmed that in the composite catalyst of Example 1, the pore volume of mesopores was greater than the pore volume of micropores in the porous aluminosilicate.

The volume of mesopores in the porous aluminosilicate was 70% of the total pore volume of the porous aluminosilicate. The average pore size of the porous aluminosilicate was 12.5 nm.

Meanwhile, it was found that the pore volume of mesopores was less than or similar to the pore volume of micropores in the composite catalysts of Comparative Examples 1 and 2.

In a pore size distribution diagram of the porous amorphous aluminosilicate of the composite catalyst of Example 1, the maximum value of differential pore volume according to the size of mesopores was 0.1 cm³/g or greater.

In a pore size distribution diagram of the porous amorphous aluminosilicate of the composite catalyst of Comparative Example 1, the maximum value of differential pore volume based on the size of mesopores was less than 0.1 cm³/g.

In a pore size distribution diagram of the porous amorphous aluminosilicate of the composite catalyst of Comparative Example 2, the maximum value of differential pore volume based on the size of mesopores having a diameter of 5 nm or greater, was less than 0.1 cm³/g.

### Evaluation Example 3: Surface Analysis of Composite Catalyst

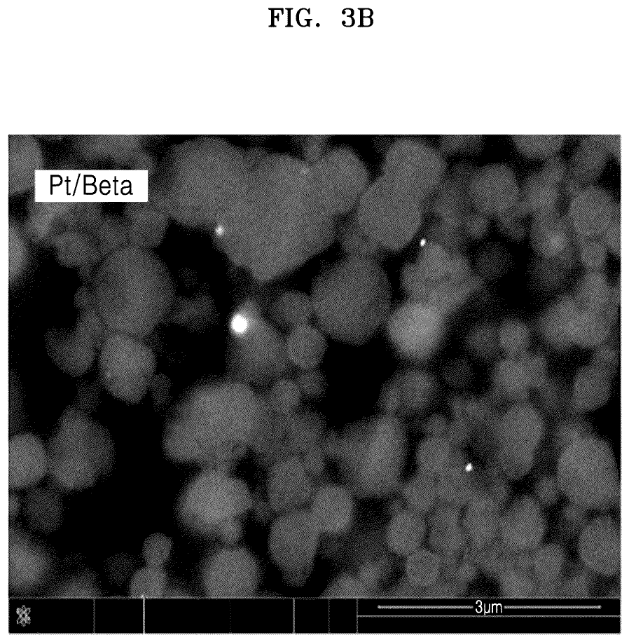

Scanning electron microscopy (SEM) images of the composite catalysts of Example 1 and Comparative Example 1 were obtained, and the obtained images are shown in FIGS. 3A and 3B.

FIG. 3A is a SEM image of the composite catalyst prepared in Example 1.

FIG. 3B is a SEM image of the composite catalyst prepared in Comparative Example 1.

As shown in FIG. 3A, it was found that the composite catalyst prepared in Example 1 has a decreased particle size of Pt particles, and Pt particles homogeneously distributed on a plurality of aluminosilicate particles, in comparison to the composite catalyst prepared in Comparative Example 1.

As shown in FIG. 3A, it was found that the composite catalyst prepared in Example 1 did not include agglomerated Pt particles having a size of 100 nm or greater.

Meanwhile, as shown in FIG. 3A, it was found that the composite catalyst prepared in Comparative Example 1 has an increased particle size of Pt particles and Pt particles selectively distributed only on some of the aluminosilicate particles, in comparison to the composite catalyst prepared in Comparative Example 1.

As shown in FIG. 3B, it was found that the composite catalyst prepared in Comparative Example 1 had agglomerated Pt particles having a size of 100 nm or greater.

### Evaluation Example 4: Composite Catalyst Cross-Sectional Analysis

Cross-sectional scanning electron microscopy (SEM) images of the composite catalysts of Example 1 and Comparative Example 1 were obtained, and the obtained images are shown in FIGS. 4A and 4B.

FIG. 4A is a cross-sectional SEM image of the composite catalyst prepared in Example 1.

FIG. 4B is a cross-sectional SEM image of the composite catalyst prepared in Comparative Example 1.

As shown in FIG. 4A, the composite catalyst prepared in Example 1 was found to contain the porous aluminosilicate support containing a plurality of mesopores, and Pt particles supported on the support.

The Pt particles were found to be supported predominantly in the outer portion of the porous aluminosilicate support. It was found that more Pt particles were supported on the outer portion of the porous aluminosilicate particle than in the inner portion.

The size of the Pt particles supported on the porous aluminosilicate was about 3.5 nm.

It was found that a plurality of pores were irregularly and nonperiodically situated inside the porous aluminosilicate support.

Meanwhile, as shown in FIG. 4B, the composite catalyst prepared in Comparative Example 1 was found to include a porous aluminosilicate support including micropores and Pt particles supported on the support.

The Pt particles were found to be homogeneously supported on the inner portion as well as in the outer portion of the porous aluminosilicate support.

### Evaluation Example 5: Measurement of Removal Performance of Volatile Organic Compound (Toluene) of Composite Catalyst (I)

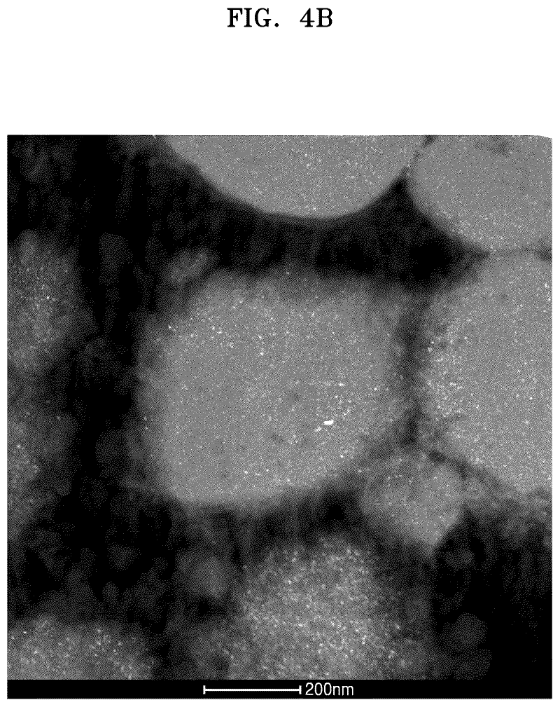

To the inlet of each of the air purification devices prepared in Example 3 and Comparative Examples 5 and 6, a toluene-containing gas was supplied as a first compound, and while the gas is discharged after passing through the filter containing the catalyst layer, the percentage of carbon dioxide (CO₂) generated (e.g., converted) from the decomposition of toluene vs. temperature was measured at the outlet. The measurement results are shown in FIG. 5. The toluene-containing gas used for the measurement had a toluene content of 10 part per million (ppm), a relative humidity of 50%, a temperature of 25° C., and a space velocity of 40,000 (milliliters per gram·hour) mL/g·hr. The toluene-containing gas contained 20% oxygen and 80% nitrogen.

As shown in FIG. 5, the point at which 100% CO₂ conversion was achieved was about 170° C. in the composite catalysts of Comparative Examples 1 and 2, but was about 145° C. in the composite catalyst of Example 1, which is less by 20° C. or greater.

As the rate of a decomposition reaction of the volatile organic compound increases by a factor of 2 (i.e., 2 times) at the same temperature, the temperature at which 100% CO₂ conversion is achieved decreased by 10° C.

It was found that the composite catalyst of Example 1 exhibited a rate of conversion to carbon dioxide from a volatile organic compound that was 4 times or more greater compared to that of the composite catalysts of Comparative Examples 1 and 2 at the same temperature because the temperature at which 100% CO₂ conversion is achieved in Example 1 is decreased by 20° C. or greater than the temperature at which 100% CO₂ conversion is achieved in Comparative Examples 1 and 2.

### Evaluation Example 6: Measurement of Removal Performance of Volatile Organic Compound (Formaldehyde) of Composite Catalyst (II)

To the inlet of each of the air purification devices prepared in Example 4 including the composite catalyst of Example 2, and Comparative Examples 7 and 8, including the composite catalysts of Comparative Examples 3 and 4, respectively, a formaldehyde-containing gas was supplied as a first compound, and while the gas is discharged after passing through the filter containing the catalyst layer, the formaldehyde removal percentage was measured at the outlet. Some of the measurement results are shown in Table 1. The formaldehyde-containing gas used for the measurement had a formaldehyde content of 10 ppm, a relative humidity of 50%, a temperature of 25° C., and a space velocity of 1,040,000 mL/g·hr. The formaldehyde-containing gas contained 20% oxygen and 80% nitrogen. The amount of formaldehyde removed was calculated from the amount of formaldehyde discharged vs. the amount of formaldehyde supplied, and the formaldehyde removal percentage was expressed as a percentage of the amount of formaldehyde removed with respect to the amount of formaldehyde supplied.

TABLE 1

| | Formaldehyde Removal Percentage [%] |
|---|---|
| Example 2 | 81 |
| Comparative Example 3 | 67 |
| Comparative Example 4 | 30 |

As shown in Table 1, the composite catalyst of Example 2 showed a significantly improved formaldehyde removal percentage at room temperature compared to that of the composite catalysts of Comparative Examples 3 and 4.

Hereinbelow, an embodiment will be described in greater detail with reference to the accompanied drawings; however, the present inventive concept is not limited to these examples. While one or more embodiments have been described with reference to the figures, it will be understood by those of ordinary skill in the art that various changes in form and details may be made therein without departing from the spirit and scope of the disclosure as defined by the following claims.

According to an aspect of the disclosure, the composite catalyst may provide improved VOC removal capacity.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composite catalyst comprising:
a support comprising an aluminosilicate, wherein the aluminosilicate comprises an amorphous aluminosilicate; and
a first particle disposed on the support,
wherein the first particle comprises a metal, a metal oxide, or a combination thereof, and
the composite catalyst is effective to remove a first compound from an unpurified air stream comprising the first compound.

2. The composite catalyst of claim 1,
wherein a ratio of a first peak intensity originating from the aluminosilicate at a diffraction angle of about 5° 2θ to about 30° 2θ to a second peak intensity originating from the first particle at a diffraction angle of about 5° 2θ to about 90° 2θ is about 0.5 or less, when analyzed by X-ray diffraction using Cu Kα radiation.

3. The composite catalyst of claim 1,
wherein the support further comprises a crystalline aluminosilicate,
wherein the support has a degree of crystallinity of about 50 percent or less,
wherein the degree of crystallinity of the support is an area under crystalline peaks divided by a total sum of an area under amorphous peaks and the area under crystalline peaks, multiplied by 100 percent, when analyzed by X-ray diffraction using Cu Kα radiation.

4. The composite catalyst of claim 1,
wherein a size of the support is about 0.5 micrometer to about 500 micrometers,
wherein the support comprises an irregular particle, a spherical particle having an aspect ratio of less than about 2, a non-spherical particle having an aspect ratio of about 2 or greater, or a combination thereof,
wherein the non-spherical particle comprises a tube-shaped particle, a plate-shaped particle, a needle-shaped particle, a rod-shaped particle, a fibrous particle, or a combination thereof.

5. The composite catalyst of claim 1,
wherein the amorphous aluminosilicate is a porous amorphous aluminosilicate,
wherein the porous amorphous aluminosilicate comprises a plurality of pores,
wherein the plurality of pores are irregularly or non-periodically arranged in the amorphous aluminosilicate.

6. The composite catalyst of claim 5,
wherein the porous amorphous aluminosilicate comprises a mesopore,
wherein a volume of the mesopore is about 20 volume percent to about 80 volume percent, with respect to a total pore volume of the porous amorphous aluminosilicate, and
wherein an average size of the mesopore is about 3 nanometers to about 50 nanometers.

7. The composite catalyst of claim 5,
wherein the porous amorphous aluminosilicate comprises a micropore and a mesopore,
wherein a pore volume of the mesopore is greater than a pore volume of the micropore in a pore size distribution diagram of the porous amorphous aluminosilicate,
wherein a maximum value of a differential pore volume of the mesopore is about 0.1 cubic centimeter per gram or greater in the pore size distribution diagram of the porous amorphous aluminosilicate.

8. The composite catalyst of claim 1,
wherein the metal comprises an element of Groups 2 to 16 of the Periodic Table of the Elements, or a combination thereof, and
wherein the metal oxide is represented by MₐO_{b}, wherein 0<a≤4, 0<b≤5, and M is an element of Groups 2 to 16 of the Periodic Table of the Elements, or a combination thereof.

9. The composite catalyst of claim 1,
wherein the metal comprises Pt, Pd, Ru, V, Ag, Mn, Ni, Zn, Co, Ce, Ti, Al, Fe, Ni, Na, In, Bi, W, Sn, or a combination thereof, and
wherein the metal oxide comprises PtO₂, PdO, RuO₂, V₂O₅, VO₂, V₂O₃, Ag₂O, MnO₂, Mn₃O₄, MnO₂—Mn₃O₄, NiO, ZnO, ZnO₂, Co₃O₄, CeO₂, TiO₂, MnO₂—TiO₂, Al₂O₃, Fe₂O₃, NaInO₂, Bi₂WO₆, SnO₂, or a combination thereof.

10. The composite catalyst of claim 1,
wherein the first particle is non-homogeneously disposed on the support,
wherein the support has
a first distance from the geometric center of the support to a surface of the support,
a second distance from a geometric center of the support to a point corresponding to 80% of the first distance, and
a third distance from the surface of the support to the point corresponding to 80% of the first distance from the geometric center of the support, and
wherein the support comprises
an inner portion defined by the second distance, and
an outer portion defined by the third distance, and
wherein an amount of the first particle disposed in the outer portion is greater than an amount of the first particle disposed in the inner portion.

11. The composite catalyst of claim 1,
wherein a size of the first particle is about 0.1 nanometer to about 10 nanometers,
wherein an amount of the first particle is about 0.1 weight percent to about 5 weight percent, with respect to a total weight of the composite catalyst, and
wherein the composite catalyst comprises 0 weight percent to about 0.01 weight percent of the first particle having a size of about 100 nanometers or greater, with respect to a total weight of the composite catalyst.

12. The composite catalyst of claim 1,
wherein the first compound comprises a volatile organic compound.

13. The composite catalyst of claim 12,
wherein the volatile organic compound comprises a polar compound, a nonpolar compound, or a combination thereof,
wherein the nonpolar compound comprises an aliphatic hydrocarbon, an aromatic hydrocarbon, or a combination thereof, and
wherein the polar compound comprises ammonia, urea, an amine compound, an aldehyde compound, a ketone compound, an alcohol compound, a sulfur compound, a thiol compound, a halogenated hydrocarbon, a nitrogen oxide, ozone, or a combination thereof,
wherein the aliphatic hydrocarbon comprises methane, ethane, propane, butane, pentane, hexane, or a combination thereof,
wherein the aromatic hydrocarbon comprises benzene, toluene, xylene, or a combination thereof,
wherein the amine compound comprises methylamine, dimethylamine,
trimethylamine, ethylamine, aniline, or a combination thereof,
wherein the aldehyde compound comprises formaldehyde, acetaldehyde, propiolaldehyde, butyraldehyde, or a combination thereof,
wherein the ketone compound comprises dimethyl ketone, methyl ethyl ketone, diethyl ketone, methyl propyl ketone, dipropyl ketone, or a combination thereof,
wherein the alcohol compound comprises methanol, ethanol, propanol, isopropanol, butanol, pentanol, hexanol, heptanol, or a combination thereof,
wherein the sulfur compound comprises hydrogen sulfide, sulfur dioxide, elemental sulfur, sulfur oxide, or a combination thereof, and
wherein the thiol compound comprises methanethiol, ethanethiol, propanethiol, butanethiol, tert-butyl mercaptan, thiophenol, or a combination thereof.

14. The composite catalyst of claim 1, further comprising
a solid substrate,
wherein the support is disposed on the solid substrate,
wherein the support and the solid substrate are positioned across the air stream, between an upstream of the air stream and a downstream of the air stream, and the support is disposed upstream of the air stream relative to the solid substrate, or
wherein the support and the solid substrate are positioned along the air stream from the upstream of the air stream to the downstream of the air stream.

15. An air purification device comprising:
a housing; and
the composite catalyst of claim 1,
wherein the composite catalyst is disposed within the housing.

16. A method of preparing a composite catalyst, the method comprising:
providing an aluminosilicate;
contacting the aluminosilicate and an alkaline solution to prepare an alkali-treated aluminosilicate;
performing a first heat-treatment on the alkali-treated aluminosilicate to prepare a heat-treated porous aluminosilicate;
contacting the heat-treated porous aluminosilicate and a strong acid to prepare an acid-treated aluminosilicate;
contacting the acid-treated aluminosilicate and a precursor solution of a first particle to prepare an aluminosilicate having a precursor of the first particle supported thereon; and
performing a second heat-treatment on the aluminosilicate having the precursor of the first particle supported thereon to prepare the composite catalyst.

17. The method of claim 16,
wherein a concentration of the alkaline solution is about 0.01 molar or greater,
wherein the strong acid comprises nitric acid, hydrochloric acid, sulfuric acid, or a combination thereof, and wherein a pH of the strong acid is less than about 1.

18. The method of claim 16,
wherein the contacting the aluminosilicate and the alkaline solution is carried out at a temperature of about 20° C. to about 100° C. for about 1 minute to about 24 hours, and
wherein the contacting the heat-treated porous aluminosilicate and the strong acid is carried out at a temperature of about 20° C. to about 200° C. for about 1 minute to about 48 hours.

19. The method of claim 16,
wherein an amount of the precursor is about 0.1 parts by weight to about 5 parts by weight, with respect to 100 parts by weight of the acid-treated aluminosilicate,
wherein the precursor of the first particle is a metal salt,
wherein the metal salt comprises an element of Groups 2 to 16 of the Periodic Table of the Elements, or a combination thereof, and
wherein the metal salt comprises a halogen salt, a nitrate, a carbonate, a phosphate, a sulfate, or a combination thereof.

20. The method of claim 16,
wherein the first heat-treatment and the second heat-treatment are each independently carried out at a temperature of about 400° C. to about 900° C. for about 1 hour to about 24 hours,
wherein a temperature of the first heat-treatment is greater than a temperature of the second heat-treatment.
